(19) United States
(12) Patent Application Publication
(10) Pub. No.: US 2012/0021887 A1
(43) Pub. Date: Jan. 26, 2012

(54) DEVICE FOR SEPARATING PACKS OF SHEET PRODUCTS AND MACHINE USING SAID DEVICE

(75) Inventors: Mauro Gelli, Capannori (IT); Alessandro Morelli, S. Pietro a Vico (LU) (IT)

(73) Assignee: Fabio Perini S.p.A., Lucca (IT)

(21) Appl. No.: 13/138,419

(22) PCT Filed: Feb. 3, 2010
(86) PCT No.: PCT/IT2010/000034

§ 371 Date: Sep. 28, 2011

(30) Foreign Application Priority Data
Feb. 13, 2009 (IT) FI2009A000029

(51) Int. Cl. B65H 33/08; B31B 1/56

(52) U.S. Cl. 493/454; 198/426

(57) ABSTRACT

The device includes a feed path for the products, along which the products move forward, divided into single packs with the interposition of at least one separator finger between one pack and the next; an oscillating support to receive packs of products and tip them onto a conveyor below; a front retaining element, which can be inserted and removed with respect to the feed path of the products to frontally retain the pile of products while the oscillating support performs an oscillation movement and deposits a pack on the conveyor below. The front retaining element is inserted in a space formed between the first and the second pack of the pile. The space is obtained by oscillating the support downwards. The oscillating support moves downwards by a first downwards angular movement and a second angular movement.

### 1. TECHNICAL FIELD

The present invention concerns a device for separating packs of sheet products from one another, for example folded paper napkins coming out of a folding machine.

The invention also concerns a folding machine comprising a separator device for dividing single packs of sheet products folded by said folding machine, for example paper napkins.

### 2. STATE OF THE ART

For the production of packages of paper napkins and handkerchiefs, folding machines of various types are used, which receive at their inlet a flat continuous web material which is transformed by the folding machine into single folded sheets forming handkerchiefs or napkins. The machine performs firstly a longitudinal fold and then a transverse fold dividing the continuous web material into single sheets folded into four. At the outlet of the folding machine the continuously delivered sheets form a pile which must be divided into single packs for transfer to a packaging machine.

Various mechanisms have been studied to divide the continuous flow of products into single packs. Examples of folding machines with devices for separating the packs of folded products are described in WO-A-2005/003010, WO-A-02/14196, WO-A-97/28076; WO-A-02/12103; EP-A-0294675, the contents of which are incorporated in the present description.

In WO-A-02/14196 in particular, a separator device is described in which separator fingers are inserted at regular intervals along a feed path of the folded sheet products, to separate groups or packs of folded products from one another, each group advantageously having the same number of folded products. The fingers move along a closed path and, at the end of the path, they are repositioned in the formation area of the pile of folded products, at the outlet of a pair of folding rollers of the folding machine. To separate one pack from the next one in the area in which the packs are discharged, at the end of the feed path an element is provided which is inserted between two successive packs, in the space created by the separator finger. This element, in the form of a stem, retains the next pack while the previous one is trans-ferred to a conveyor below by means of an oscillating element. A front retaining element is inserted in the space left empty by the pack which is tipped downwards, to retain and feed forward the front of the pile of folded products. This known device, although much simpler and more reliable than other earlier devices like those described in the above publications, is nonetheless rather complex. In fact, to perform the functions of dividing the continuous flow of products into single groups of packs and to individually discharge each pack, tipping it from the position in which it comes out of the folding machine to a position rotated by 90° onto a discharge conveyor, various elements operated synchronously are required, namely:
the separator fingers;
the oscillating support;
the front retaining element;
the stem which, before tipping of the first pack of the pile and insertion of the front retaining element, is inserted between one pack and the next in the space left free by the separator finger.

The movement of these four elements must be accurately synchronized.

### SUMMARY OF THE INVENTION

The invention concerns a separator device of the above-mentioned type, comprising: a feed path for the products, along which the products are fed, divided into single packs with the interposition of separator fingers, at least one separator finger being positioned between one pack and the next one; an oscillating support to receive packs of products and tip them onto a conveyor below; a front retaining element, which can be inserted and removed with respect to the product feed path to frontally retain the pile of products and move forward with it while the oscillating support performs an oscillating movement and deposits a pack on the conveyor below. Advantageously, the front retaining element and the oscillating support are arranged and controlled so that each pack positioned on the oscillating support is detached from the pile, which moves forward in the feed direction, by means of a first downwards angular movement of the oscillating support, coordinated with the insertion movement of the front retaining element, which is controlled in order to be inserted in the space formed by said first angular movement between the pack on the oscillating support and the next product, to retain the pile and move forward with it.

Substantially, in the area where the single packs of folded products are discharged, at the end of the feed path, the first pack is separated from the subsequent one and discharged via the cooperation of only three mechanical elements: the respective separator finger, previously positioned between the two adjacent packs, and the front retaining element and oscillating support, without the need for a stem temporarily inserted in the pack feed path, to temporarily retain the next pack until insertion of the front retaining element. In fact it has surprisingly been found that, despite the soft and flexible nature of the material (usually crepe paper, i.e. so-called tissue paper) used for the production of paper napkins and handkerchiefs, the behavior of the folded products is such that when the front pack, i.e. the pack farthest forward in the pile, is lowered slightly by an angular movement of the oscillating support, it remains sufficiently stable and is not upset, so that substantially the last napkin or other folded sheet product of the front pack moves away from the first product of the next pack, forming a substantially wedge-shaped free space in which the front retaining element can be inserted without the need for further supporting elements. Therefore, in some preferred embodiments of the invention, control of the subsequent pack and the front retention thereof is obtained by the sequential action of the respective separator finger and the front retaining element. The separator finger frontally retains the pack following the one to be discharged, until the front retaining element is inserted in the feed path following an angular movement of the oscillating support. At this point, without the need for any further operations or intervention of other mechanical elements, the separator finger can be moved away from the feed path while the first pack can be discharged by a further angular movement of the oscillating support which transfers it towards the conveyor below.

During this sequence of movements, the pack farthest forward can be discharged by a tipping movement for example by 90° of the oscillating support. Preferably, the tipping movement occurs in two steps, with a consent signal provided according to the movement of the front retaining element. When the latter is inserted in the product feed path and can frontally engage the next pack, the consent is given for completion of the tipping movement of the first pack.

The separation and discharge system obtained is much simpler than other very complex mechanisms described in the other above-mentioned publications, which in some cases even require pairs of separator fingers, with a mechanism that acts on each pair to divaricate the separator fingers.

The lowering movement, i.e. the downwards oscillating movement of the oscillating support, can be a continuous movement, appropriately synchronized with the movement of the front retaining element. However, for greater simplicity and improved reliability of the device, it has been found that it is preferable to use a dual oscillation movement with a first angular stroke, subsequent stoppage of the oscillating element until insertion of the front retaining element, and a subsequent second movement or angular stroke of the oscillating support which positions the pack on the conveyor below. In some embodiments this dual movement can be obtained by a dual cylinder-piston actuator, for example pneumatic or, preferably, hydraulic. The control and synchronization of the various components of the device becomes much simpler and more reliable.

The first oscillation stroke, i.e. the first angular movement, can be limited to a few degrees, for example 2-15°, and preferably 5-10°, while the second stroke completes the downward oscillation, equal overall to approximately 90° or slightly above, to guarantee release of the pack onto the conveyor below. Therefore the pack that is formed by vertically arranging the sheet products, is then positioned with the products in a substantially horizontal position.

In the context of the present description reference will be frequently made to folded products, in particular paper napkins, but the present invention can also be applied more generally, in other fields and for the handling of sheet products of other type, in particular sheet products, when similar problems occur.

### BRIEF DESCRIPTION OF THE DRAWINGS

The invention will be better understood by following the description and accompanying drawing which shows a possible non-limiting embodiment of the invention. More specifically in the drawing:

FIG. 1 is a plan view of a folding machine comprising a device according to the invention;

FIG. 2 is an enlarged plan view, according to the line II-II of FIG. 3, of the terminal area of the feed path of the pile of sheet products;

FIG. 3 is a section according to of FIG. 2;

FIG. 4 is a front view of the front retaining element for the packs of products;

FIG. 5 is a view according to V-V of FIG. 4;

FIG. 6 is a plan view of the oscillating support for tipping the packs of products;

FIG. 7 is a section according to VII-VII of FIG. 6; and

FIG. 8A-8D are schematic representations of the sequence of movements for the discharge of a pack of products onto the outlet conveyor.

### DETAILED DESCRIPTION OF AN EMBODIMENT OF THE INVENTION

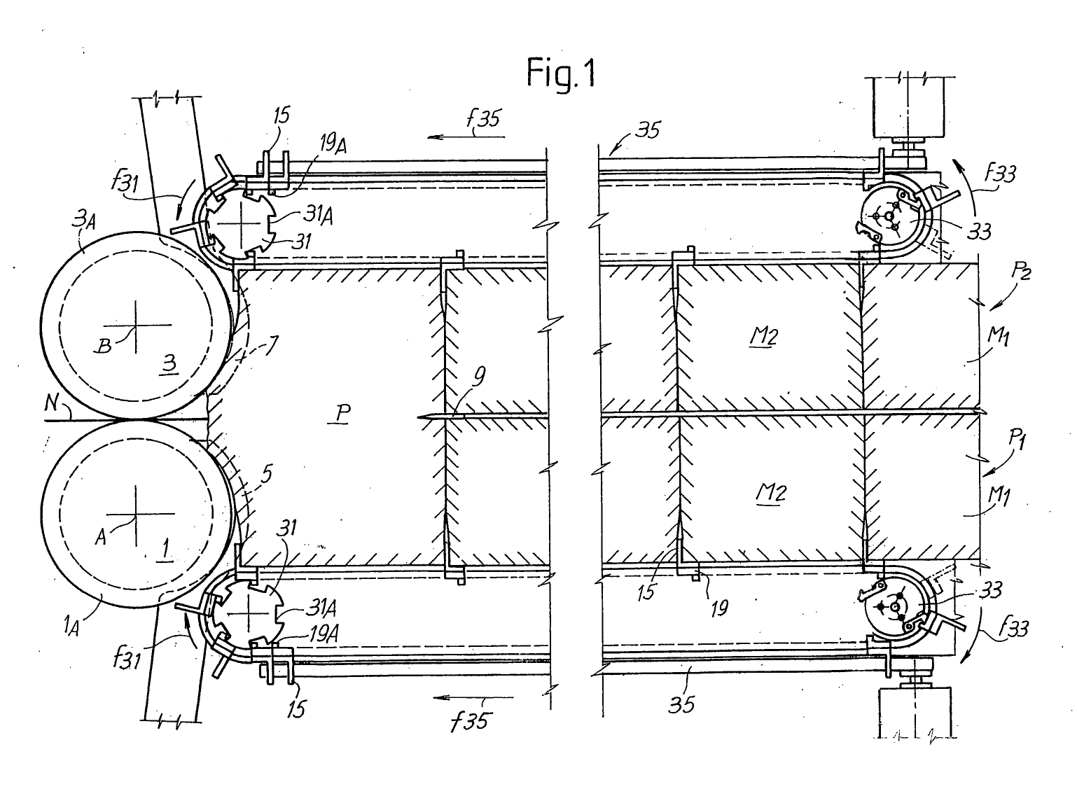

In the accompanying drawing, and with initial reference in particular to FIG. 1, 1 and 3 indicate two folding rollers of a folding machine for the formation of a pile P of napkins or other folded sheet products. The folding rollers 1 and 3, which rotate around respective vertical axes A and B, have annular grooves 1A, 3A housing arched arms 5 and 7 which detach the folded material from the respective roller and push it against the pile P of products already formed, at the machine outlet. A continuous web material N, folded along a longitudinal line if required, is fed into the nip formed between the two rollers 1 and 3 which are combined with systems known per se which fold the material coming out of the nip once around the roller 1 and once around the roller 3 to produce a pile of zigzag folded material. At each fold the respective arched arm 5, 7 detaches the material from the roller and pushes it towards the already formed pile P.

The operation of the folding machine summarily described is known per se and will therefore not be illustrated in further detail.

The pile P of folded web material is pushed against a transverse blade 9 which cuts the pile into two parts P1 and P2 each formed by a plurality of napkins folded in two or in four. Downstream of the blade 9 a partition wall is arranged which keeps separate the two parts P1, P2 into which the pile has been cut, allowing independent handling of said two parts.

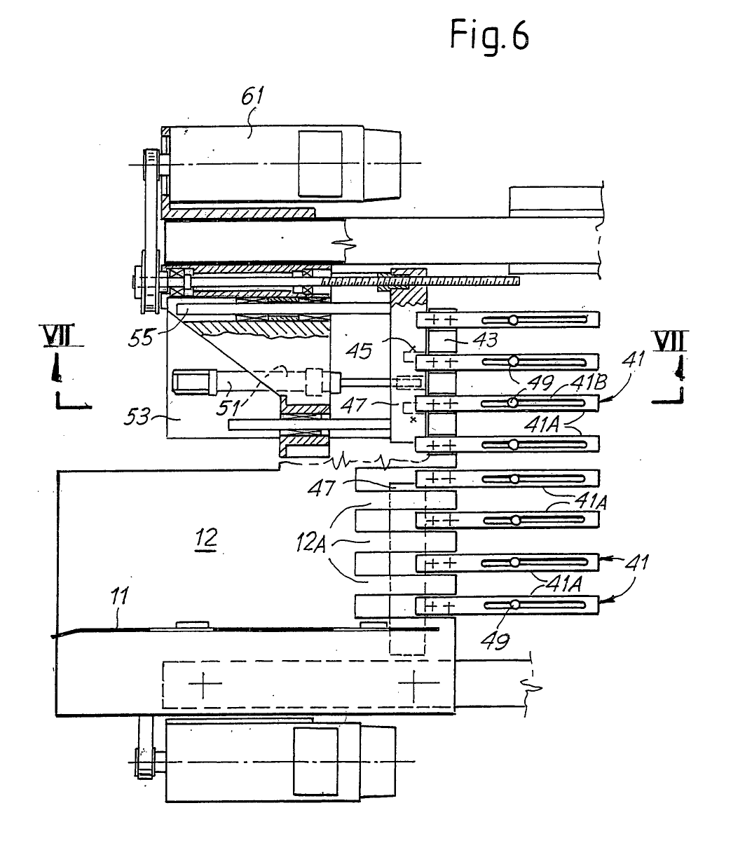

The pile P, P1, P2 moves along a feed path defined by a feed channel delimited by a pair of sideboards 11 (see also FIGS. 5, 7 and 8) and by a bottom wall 12, at the end of which packs M1, M2 . . . Mn of napkins are discharged, each containing a predefined number of products.

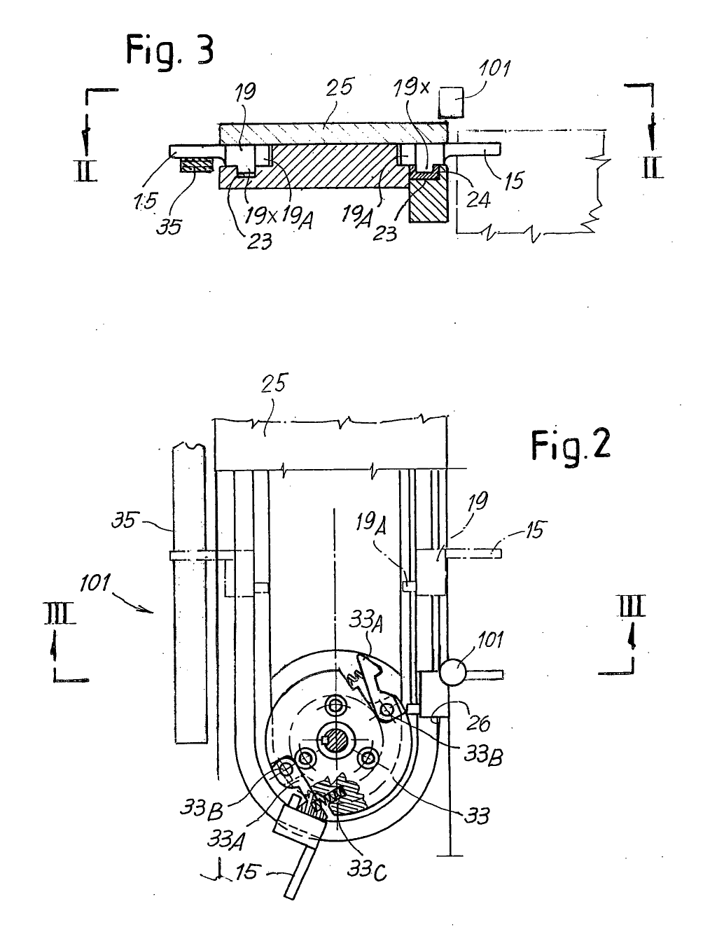

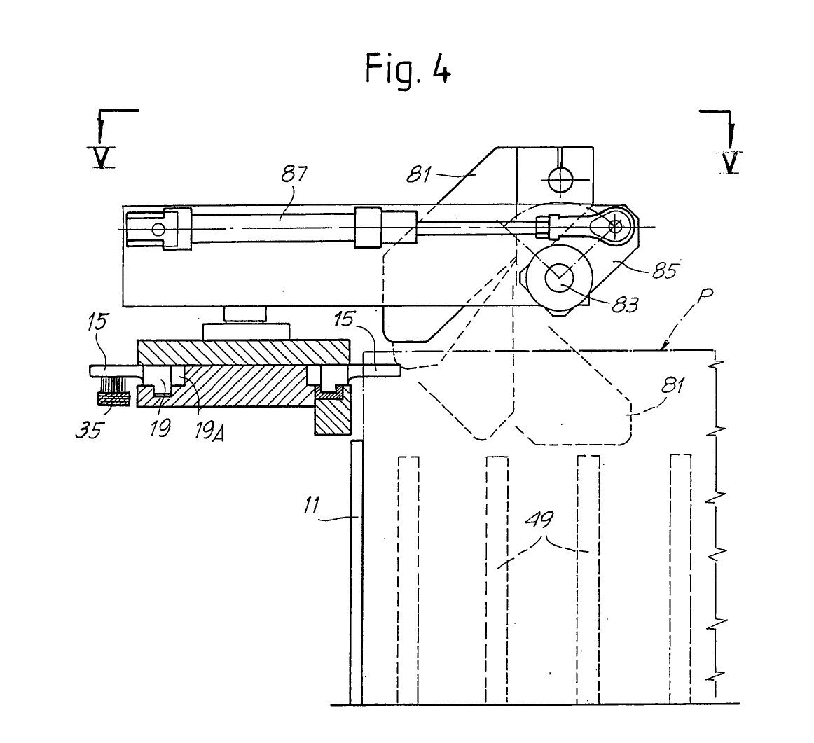

To separate a pack of napkins M1 from the next pack M2, at the sides of the feed channel of the pile P, P1, P2 two sets of separator fingers 15 are arranged, one on each side of the channel, defining the feed path of the packs of folded sheet products. Each separator finger 15 is integral with a respective cursor 19, which runs in a respective guide. The arrangement can be seen in particular in FIGS. 2 and 3. On each side of the feed channel of the pile P, P1, P2 a corresponding guide 23 is arranged, inside which the cursors 19 of the separator fingers 15 run, said guide being closed at the top by a lamina 25 made of material with a low friction coefficient to allow the cursors 19 to run smoothly. Each guide 23 has two rectilinear sections joined, near the folding rollers and near the area in which the packs of folded products are discharged, by terminal curved portions.

In some embodiments the guide 23 houses inside it and along the internal rectilinear section, i.e. the one nearest the feed channel of the pile of napkins, a feed belt 24 with a U section, which defines a seat for engagement of the lower teeth 19× provided on the cursors 19. The belt has an adjustable feed speed approximately equal to the feed speed of the pile P of products, to control the feed movement of the fingers 15 and the cursors 19.

Alternatively the belt 24 can be omitted and the cursors 19 can engage directly in a fixed slide channel with a low friction coefficient forming the guide 23. In said case the forward movement of the cursors is obtained by the pushing action of the pile of folded products.

In some embodiments, each cursor is furthermore provided with a rear appendix 19A for the purposes which will be described later on.

The guides 23 define a closed path and in each of them an equal number of cursors 19 are preferably arranged, so that on each side of the feed channel each cursor 19 and the relative finger 15 in the guide 23 correspond to a cursor 19 and a corresponding finger 15 in the guide 23 on the opposite side of the feed channel of the folded products.

At the level of the two terminal curved areas of each guide 23 are a respective first grooved sprocket 31 (near the respective folding roller 1, 3) with a series of longitudinal grooves 31A, and a second sprocket 33 (in the discharge area).

In some embodiments, to each sprocket 33 two hooks 33A are hinged (cf. in particular FIG. 2) around axes parallel to the axis of rotation of the sprocket 33 and elastically pushed by springs 33C to protrude from the periphery of the sprocket 33. The hooks 33A engage each cursor 19 by means of the appendixes 19A of the latter, provided on the rear part (i.e. opposite the separator fingers 15) of each cursor 19.

The clockwise step rotation (arrow f31) of the first grooved sprocket 31 causes the rear appendixes 19A of the cursors 19 to be hooked by the grooves 31A, hence the cursors 19 are transferred from the respective external rectilinear section of the guide 23 to the internal rectilinear section thereof, i.e. the section facing the pile P of products. The step rotation of the grooved sprocket 31 can be obtained with any suitable system, for example with a freewheel mechanism operated by a linear cylinder-piston actuator, or by a rotary actuator. Analogously the rotation of the second sprocket 33 in the direction of the arrow f33 causes hooking and transfer of the cursors 19 and the fingers 15 integral therewith from the internal rectilinear section to the external rectilinear section of the respective guide 23.

A continuous flexible element 35 extends on each side of the feed channel of the pile P, P1, P2 of products and parallel to the external rectilinear section of each guide 23, is entrained around two pulleys and is provided with bristles which engage the fingers 15 transferred from the second sprocket 33 onto the external rectilinear section of the respective guide 23 and feed them according to the arrow f35 in the direction opposite to the feed direction of the pile P, P1, P2 of products. The cursors 19 are conveyed by the flexible element 35 until they abut against the first sprocket 31, as can be seen in FIG. 1. Several fingers 15 are stacked against the sprocket 31, while the flexible element 35 can run below them by deformation of the bristles with which said element is provided. At each rotation of the first sprocket 31 the fingers 15 stacked against it are pushed so that they accumulate in the waiting area. The number of fingers 15 waiting, leaning against the sprocket 31, depends on the dimension of the packs of products M1-Mn being formed: the greater the dimension of each single pack, the greater the number of pairs of fingers 15 waiting.

Near the terminal area of each guide 23 (i.e. farthest from the folding rollers 1, 3) a sensor 101 is positioned to detect the passage of a respective separator finger 15. The sensor can be a microswitch, a capacitive proximity sensor, a magnetic sensor or any other element for detecting the presence or passage of the separator fingers 15, for the purposes clarified below.

The device described so far operates as follows.

The folding rollers 1 and 3 rotate continuously forming the pile P, which is then cut by the blade 9 into the two parts P1, P2. In this phase, adjacent to each roller 1 and 3 a respective separator finger 15 is waiting outside the folding area. When a predefined number of folds has been reached, which will form a predefined number of napkins due to the cut performed by the blade 9, on each side of the machine the respective grooved sprocket 31 rotates by one step bringing the cursor 19 and therefore the respective separator finger 15 from the position away from and outside the folding rollers to the folding area, in a position farther forward than the point in which the subsequent fold of the web material N will be formed. Said movement is made possible by the presence of annular grooves in the folding rollers 1 and 3. The cursors 19 are totally released from the grooved sprocket 31 and fit with the lower appendixes 19X into the respective longitudinal seats of the belts 24 arranged in the guides 23, along the section of path facing the feed channel.

Continuing the feed and therefore folding of the web material N with accumulation of folded material in the pile P, the two fingers 15 on the two sides of the feed channel, fed by the respective grooved sprockets 31 into the active folding area, remain engaged between one fold and the next and begin to move forward along the guides 23 pushed by the same pile P, P1, P2 of products moving forward due to the action of the arms 7, assisted by the action of the respective feed belts 24, the feed speed of which is (as mentioned previously) approximately equal to the feed speed of the pile P.

When the two cursors 19 on the two sides of the feed channel of the pile P, P1, P2 reach the end of the rectilinear section of the guides 23, a separation and discharge sequence of the first group of products or napkins M1 from the subsequent group M2 is started by the pair of separator fingers 15, the passage of which is detected by the respective sensor 101. The sequence will be described in further detail below.

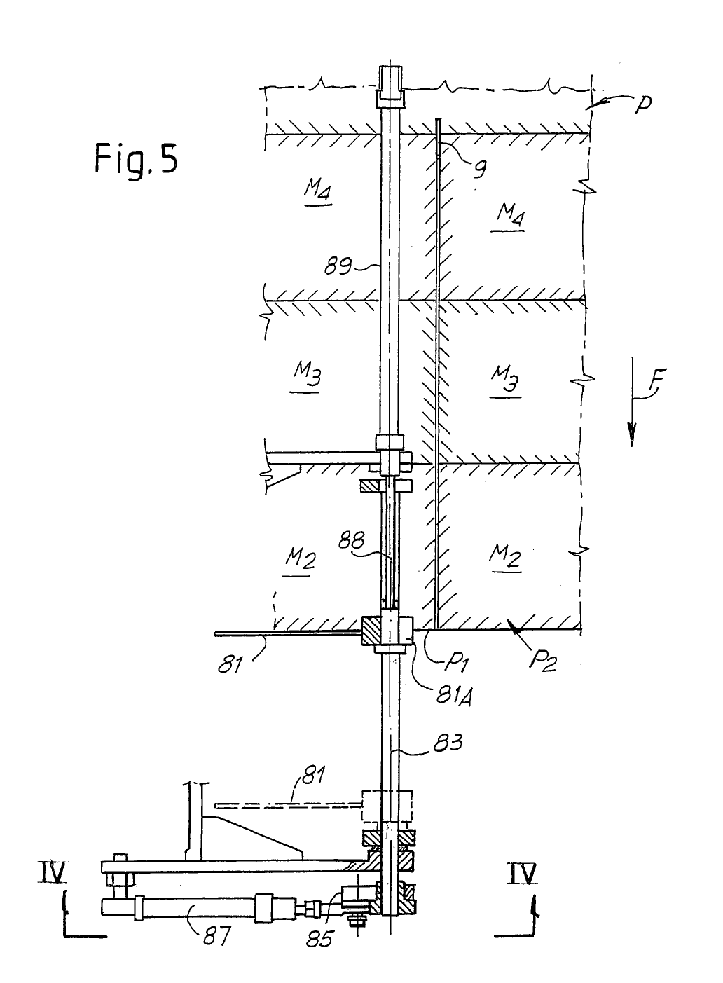

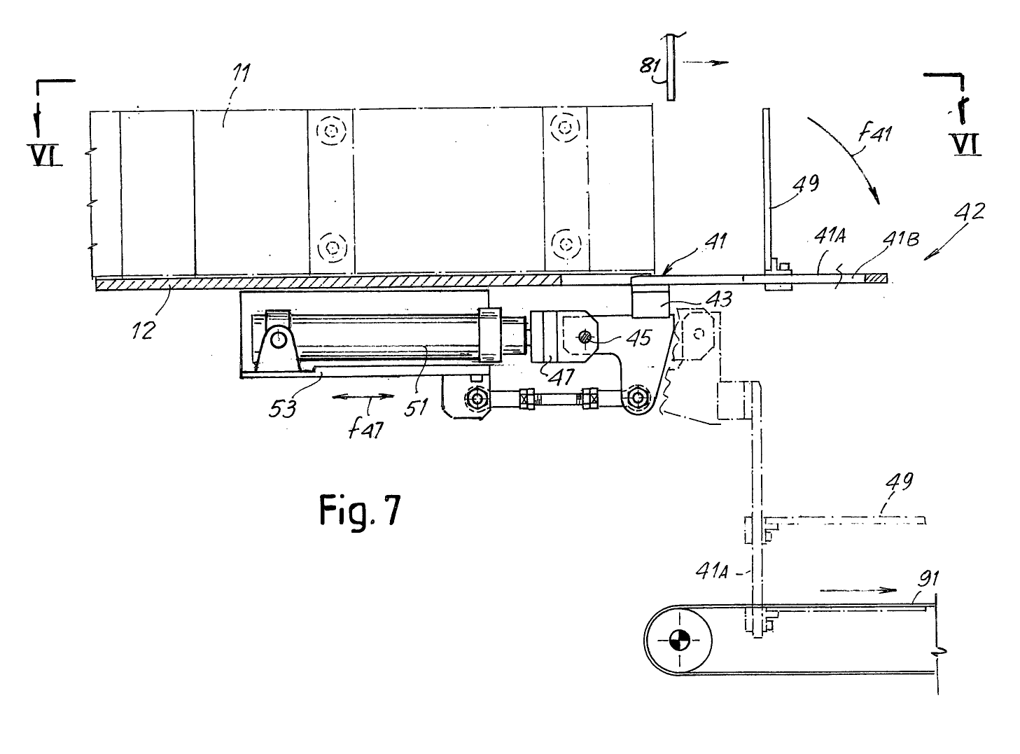

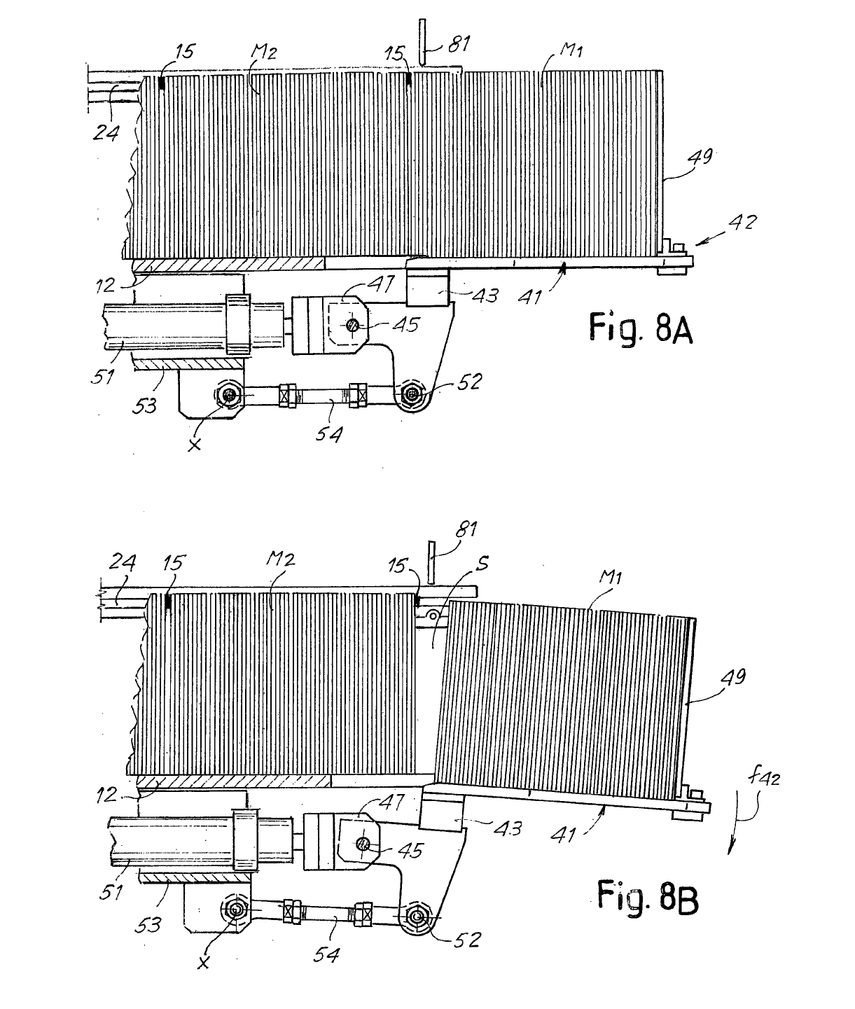

Each pack M1, M2, . . . Mn of products must be discharged onto an outlet conveyor 91 below (see in particular FIG. 7), after rotation by 90°, so that the products are lying on a substantially horizontal plane. The tipping and discharge means for the single packs M1, M2 . . . Mn of products separated by means of the separator fingers 15 are illustrated in particular in FIGS. 4 to 7 and are substantially equivalent to those described in detail in WO-A-9728076 and in WO-A-02/14196, the contents of which are incorporated in the present description and summarily described below.

The wall 12 defining the bottom of the feed channel of the pile P, P1, P2 terurinates in a comb portion 12A which cooperates with a movable surface 41 defined by a plurality of laminae 41A supported by a bracket 43 jointed at 45 to a block 47. Each lamina 41A has a slot 41B inside which a bar 49 engages, in an adjustable position, orthogonal to the surface 41. The bars 49 are aligned with one another to define the above-mentioned vertical abutment surface for containing the pile of products.

The surface 41 formed of the laminae 41A defines an oscillating support, indicated by 42 as a whole. It can be tipped around the horizontal axis 45 by a cylinder-piston actuator 51. Furthermore, the block 47 with the plate 53, the actuator 51 and the surface 41 can translate according to the double arrow f47 by means of a mechanism shown in FIG. 7 known per se and not described in further detail, comprising an actuator 61.

The blade 81 is arranged above the surface 41, constituting a front retaining element for the packs of products M1, M2, . . . Mn. The blade 81 is operated for example by a mechanism illustrated separately in particular in FIGS. 4 and 5. The blade 81 is connected to a shaft 83 developing parallel to the feed direction F of the pile P, P1, P2 of products so as to oscillate integrally with the shaft around the axis of the latter. The shaft 83 is connected by means of an arm 85 to a cylinder-piston system 87 which controls the oscillation thereof around its own axis thus causing oscillation of the blade 81 between an upper position away from the pile P, P1, P2 (shown by a continuous line in FIG. 4) and a lower position (shown by a broken line in FIG. 4) in which the pile of products rests on the blade.

The support 81A of the blade 81 (FIG. 4) is furthermore connected to the stem 88 of a further cylinder-piston actuator 89 which moves the blade 81 in a direction parallel to the feed direction F of the pile P.

The arrangement now described is symmetrical, since an adjacent pair of blades 81 are provided, one corresponding to each portion P1, P2 of the pile of products coming from the machine.

Instead of the blade 81 with the mechanism described above for insertion and removal of the packs of products M1, M2, . . . Mn with respect to the feed path, front retaining elements of different form can be used, having the same function described below in further detail.

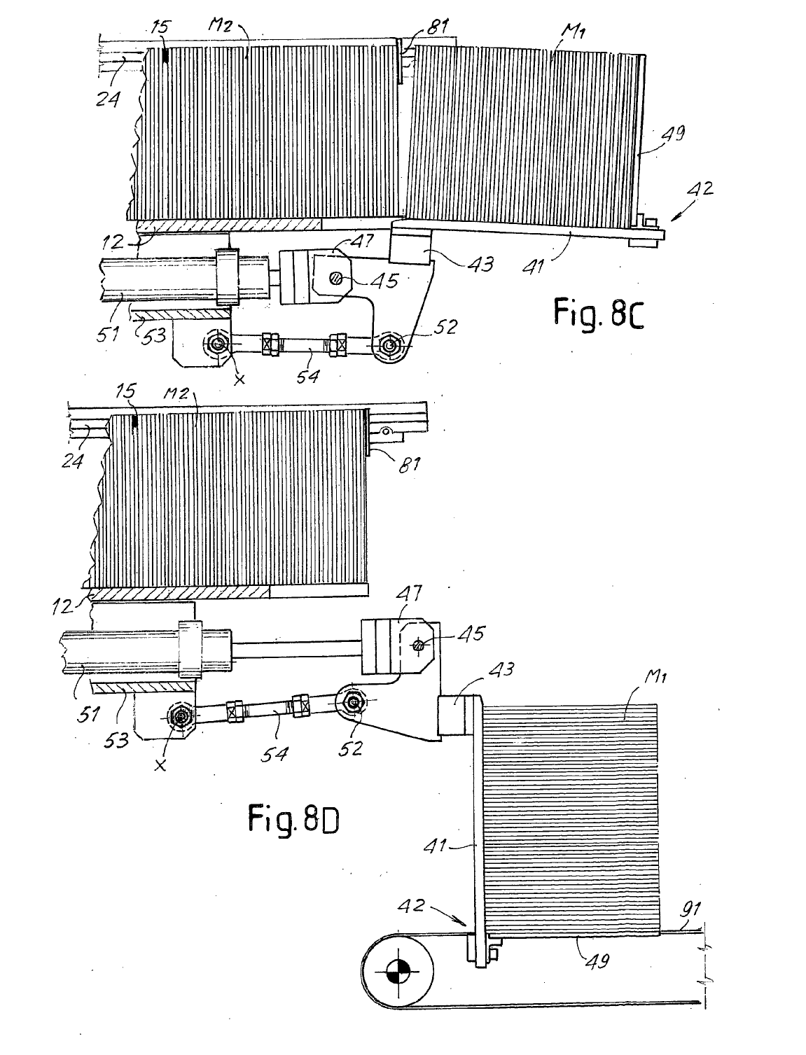

The operations for discharge of the packs of products are performed as follows (see in particular also FIG. 8A-8D). In the following description reference will be made to the operating sequence for discharge of one pack M1, but in practice movements can be performed simultaneously and symmetrically for discharge of the two packs M1 farthest forward in the pile, obtained by cutting of the zigzag folded product by the blade 9.

The bars 49 are set initially to their position nearest the folding rollers 1 and 3 and the products farthest forward in the pile P, P1, P2 rest on the bars 49 and are pushed against them. As the web material N is folded and the napkins are formed by the rollers 1, 3 and by the blade 9, the bars 49 translate under the control of the motor 61 to make way for the new products coming from the machine.

The sensor 101 emits a signal when a pair of fingers 15 reaches the position of FIGS. 2 and 8A. This signal represents the consent for starting the discharge cycle of the pack M1 of napkins, which is performed as follows: having detected the presence of the separator fingers 15, a control unit sends a command signal to the actuafor 51 which causes a first angular movement of the oscillating support 42 which thus begins to move down towards the outlet conveyor 91 below, as shown in FIG. 8B. This first angular movement, indicated by the arrow f42, can be limited to approximately 5-10°. In some embodiments, as shown in FIG. 8A-8D, the angular movement is not performed around a fixed axis but around a pin 52 connected by means of a tie rod 54 to a hinge with temporarily fixed axis X.

As a result of said angular movement, a space S is created between the farthest forward pack of products M1 on the oscillating support 42 and the next pack M2. The first sheet product of the pack M2 is retained at the top by the separator finger 15, while the last sheet product of the pack M1 remains resting on the pack due to its own weight for a time sufficient to permit insertion of the blade 81 or other front retaining element in the space S thus formed. The front retaining element 81 frontally engages the pack M2 following the one placed on the oscillating support 42, as shown in FIG. 8B. The control or front retention of the pack M2, therefore, is performed initially by the pack M1 and subsequently by the separator finger 15 and the front retaining element 81.

At this point the separator finger 15 can be moved away from the feed path or channel of the packs of products by an angular movement of the sprocket 33 and transferred to the return path, outside the feed path of the packs, towards the sprocket 31 for re-use in a subsequent phase.

FIG. 8C shows the subsequent step, when the front retaining element 81 is inserted in the space S and has come into contact with the pack M2 following the one to be discharged. The front retaining element 81 begins to move forward together with the pile of packs, the formation of which is continuous with consequent shifting of the pack M2 from left to right (in the drawing). The respective finger 15 moves forward freely to the position in which it is fed into the return path. Indeed, from the moment when the blade or front retaining element 81 has come into contact with the front surface of the pack M2 farthest forward in the pile, the separator forger no longer has any function.

The oscillating support 42 can complete its downwards angular movement to discharge the pack M1 onto the outlet conveyor 91 below, performing an angular stroke complementary to the one that formed the space S, until reaching the position illustrated in FIG. 8D. The bars 49 are positioned below the feed surface of the conveyor 91, so that the movement of the latter can move the pack M1 away. The pile of packs under formation continues to move forward gradually and is retained frontally by the front retaining element 81 which moves forward together with the most advanced pack M2 in the feed channel or path.

Subsequently the oscillating support 42 is re-set to the initial position, with the surface 41 in a substantially horizontal position and aligned with the bottom wall 12 to receive the next pack M2. The bars 49 are re-positioned against the front surface of the pile in the process of formation and the front retaining element 81 can be removed from the feed path of the pile of products as follows.

Once the pack M1 has been deposited on the conveyor 91 and moved away from the discharge area by means of the conveyor 91 itself, the oscillating support 42 is moved back up by the cylinder-piston actuator 51, while the actuator 61 moves the assembly 41, 43, 47, 49 back to a position in which the bars 49 come into contact with the front surface of the pack M2. This position is determined by a PLC or other control unit of the actuator 61 according to the thickness values of the web material N and production speed, since in the meantime the blade 81 has moved forward under the pushing action of the pile of products to allow continuous operation of the folding machine without a substantial increase in compression of the products. Before the surface 41 and the bars 49 return to their position resting against the pile being fed forward, the fingers 15 inserted between the pair of packs M1 and the pair of packs M2 are moved away by the sprockets 33, so that the pack M2 is retained in the last phase only by the blade or front retaining element 81 which is free to move forward under the pushing action of the pile P elongating the stem of the cylinder-piston system 89.

When the bars 49 come into contact again with the first napkin of the forward moving pile, the blade or front retaining element 81 is moved upwards and away by means of the actuator 87 and retracted in the initial position by means of the actuator 89.

Advantageously, the dual angular movement of the oscillating support 42 can be performed in a way that can be easily controlled and coordinated with the movements of the remaining elements of the device by providing an actuator 51 which is a dual actuator, for example consisting of a dual cylinder-piston element, the first performing the first angular stroke (FIG. 8A-8B) and the second performing the second angular stroke (FIG. 8C-8D). This allows more accurate and reliable control and synchronization.

As can be seen in the accompanying figures, the actuators and devices that allow discharge of the packs of products are dual and symmetrical, since discharge of the packs M1 from the two portions P1 and P2 into which the pile P has been cut can also be non simultaneous.

From the above it can be seen that the separator device is substantially simpler than the known devices, since moving away and discharge of each pack of products M1, M2, . . . Mn is performed using fewer mechanical elements than the known devices, with consequent advantages in terms of construction and control. It is understood that the drawing only shows an example provided as a practical demonstration of the invention, which can vary in terms of form and arrangement without departing from the scope of the concept underlying the invention. Any reference numbers in the attached claims are provided to facilitate reading of the claims with reference to the description and the drawing, and do not limit the scope of protection of the claims.

1-16. (canceled)

17. A device for dividing a pile of sheet products into packs and for separating said packs from one another, comprising: a feed path for the sheet products along which said sheet products are fed forward and divided into single packs with an interposition of at least one separator finger between one pack and a subsequent pack; an oscillating support to receive the packs and tip the packs onto a conveyor below; a front retaining element, which is inserted and removed with respect to the feed path to frontally retain the pile of products while the oscillating support performs an oscillation movement and deposits a pack on the conveyor below; wherein the front retaining element and the oscillating support are structured and arranged so that each pack positioned on the oscillating support is moved away from the subsequent pack and is moved forward along the feed path by a first downwards angular movement of the oscillating support, which is coordinated with movement for insertion of the front retaining element, said front retaining element being inserted in a space formed by said first angular movement between a pack on the oscillating support and a subsequent pack.

18. The device according to claim 17, wherein the oscillation movement of the oscillating support and the insertion of the front retaining element are coordinated so that each of the packs subsequent to the pack to be discharged onto said conveyor below is frontally engaged by said front retaining element as soon as the pack to be discharged is moved away by said first angular movement.

19. The device according to claim 17, wherein said oscillating support performs the oscillation movement and discharge of the pack onto the conveyor below in a first step and a second step, said first angular movement being in the first step and the pack tipping onto the conveyor below being completed in the second step.

20. The device according to claim 18, wherein said oscillating support performs the oscillation movement and discharge of the pack onto the conveyor below in a first step and a second step, said first angular movement being in the first step and the pack tipping onto the conveyor below being completed in the second step.

21. The device according to claim 17, further comprising a dual actuator which provides the oscillation movement of said oscillating support.

22. The device according to claim 18, further comprising a dual actuator which provides the oscillation movement of said oscillating support.

23. The device according to claim 19, further comprising a dual actuator which provides the oscillation movement of said oscillating support.

24. The device according to claim 23, wherein said dual actuator performs said oscillation movement in two steps.

25. The device according to claim 20, further comprising a dual actuator which provides the oscillation movement of said oscillating support, and wherein said dual actuator performs said oscillation movement in two steps.

26. The device according to claim 17, wherein said oscillating support further provides a second movement for discharging the pack positioned on the oscillating support, said second movement being provided on a time basis so that the second movement starts after the front retaining element is inserted in the feed path.

27. The device according to claim 17, wherein in a terminal area of the feed path of the at least one separator finger along a guide is an element for blocking and transferring individual finger of the at least one separator fingers from the feed path to a return path.

28. The device according to claim 27, further comprising a mechanism for transferring the individual fingers from the return path to the feed path, in synchronization with division of said pile of products into the packs.

29. The device according to claim 17, wherein a separator finger of the at least one separator finger which is positioned between the pack arranged on said oscillating support and the subsequent pack is removed from the feed path after the oscillating support has provided said first angular movement downwards and said front retaining element has engaged the subsequent pack.

30. A folding machine comprising a pair of folding rollers, between which a web material is folded zigzag, and a blade which divides the web material folded zigzag into two piles of folded products which move forward side by side; wherein a device according to claim 17, 18, 19, 21, 26, 27, 28 or 29, divide the two piles into the packs of products and separate said packs from one another.

31. A method for dividing a pile of sheet products into packs and separating said packs from one another, comprising steps of:
inserting at least one separator finger between a first pack and a subsequent pack;
feeding forward said first pack and said subsequent pack with the at least one separator finger along a feed path;
arranging the first pack on an oscillating support at an end of said feed path;
forming a space between said first pack and the subsequent pack by a downward angular movement of said oscillating support;
inserting a front retaining element in said space to frontally retain said subsequent pack;
completing the downwards angular movement of said oscillating support until said first pack is discharged onto a conveyor below, while said subsequent pack is retained by said front retaining element.

32. The method according to claim 31, wherein said oscillating support performs:
a first angular movement downwards, said front retaining element being inserted in a space formed between the first pack and the subsequent pack by said first angular movement;
after insertion of the front retaining element, a second angular movement in a common direction with the first angular movement which discharges said first pack onto said conveyor below.

33. The method according to claim 31, wherein said at least one separator finger is controlled so that a separator finger thereof inserted between the first pack and the subsequent pack is removed from the feed path after said space has been formed and said front retaining element is inserted in the feed path.

34. The method according to claim 32, wherein said at least one finger is controlled so that a separator finger thereof inserted between the first pack and the subsequent pack is removed from the feed path after said space has been formed and said front retaining element is inserted in the feed path.

35. The method according to claim 31, wherein said front retaining element moves forward with said subsequent pack while the first pack is discharged by said oscillating support onto a conveyor below.

36. The method according to claim 31, wherein during discharge of each pack onto said conveyor, the subsequent pack is retained in succession initially by a respective one of said at least one separator finger and subsequently only by said front retaining element.

37. The method according to claim 31, wherein the subsequent pack is initially retained frontally by said first pack and, after said first angular movement downwards of said oscillating support, said subsequent pack is directly engaged by said front retaining element.
